(19) United States
(12) Patent Application Publication
(10) Pub. No.: US 2010/0070256 A1
(43) Pub. Date: Mar. 18, 2010

(54) METHOD, SERVER, AND SYSTEM FOR IMPROVED DATA NETWORK

(76) Inventors: Arvid Nilsson, Lund (SE); Björn Smedman, Lund (SE); Christian Smedman, Stockholm (SE)

Correspondence Address: HARNESS, DICKEY & PIERCE, P.L.C., P.O. BOX 8910, RESTON, VA, 20195, US

(21) Appl. No.: 12/312,673

(22) PCT Filed: Nov. 26, 2007
(86) PCT No.: PCT/EP2007/062811

§ 371 Date: Sep. 28, 2009

Related U.S. Application Data
(60) Provisional application No. 60/860,962, filed on Nov. 27, 2006.

(51) Int. Cl. G06F 17/50

(52) U.S. Cl. 703/13

(57) ABSTRACT

There is provided a method for predicting performance in a data network, wherein the method includes, in at least one embodiment, associating one of at least one geographical positions with a set of client communications link measurements related to a client device at a time instant, and predicting a first performance factor pertaining to an access point communications link between a new access point at the geographical position and one of a number of existing access points. In at least one embodiment, the prediction is based on a subset of the set of client communications link measurements, and the subset is associated with one of the number of existing access points.

### CROSS-REFERENCE TO RELATED APPLICATION

This application claims the benefit of priority to the U.S. provisional patent application Ser. No. 60/860,962, filed on Nov. 27, 2006.

### TECHNICAL FIELD

The present invention relates to a method for predicting performance in a data network, and a server, a system and a computer product thereof. The invention further relates to a method for predicting a network performance factor in a data network, and a method for deploying a data network.

### BACKGROUND

Combined wired and wireless data networks offer a cost effective solution for providing mobile and fixed Internet access in urban areas. Most of the cost benefit of this technology comes from the fact that some, but not all, access points have a wireless connection to the Internet. Network traffic is routed to and from client devices over radio links between access points using a routing algorithm.

Much of the cost of such networks lay in planning the network, installing the network nodes and maintenance. Deals have to be negotiated with property owners and equipment must be purchased, installed and serviced. Compared to the very low cost of e.g. high volume consumer grade IEEE 802.11 (Institute of Electrical and Electronics Engineers) wireless hardware the cost for this can be substantial.

In order to achieve a data network with good coverage and performance properties a number of factors must be considered. One problem that arises is how to properly place a number of access points in a data network. A second problem is how to control the growth of such a data network.

### SUMMARY

In view of the above, an object of the invention is to solve or at least reduce the problems discussed above. In particular, an objective is to provide a method for predicting performance in a data network. A second object is to provide a method for predicting a network performance factor in a data network. A third object is to provide a method for deploying a data network. A fourth object is to provide a server thereof. A fifth object is to provide a system thereof. A sixth object is to provide a computer program product thereof.

The construction of a data network from low cost access point hardware is considered to be part of the state of the art. This invention discloses the process of planning the network, negotiating deals, installing and servicing access points and thereby achieving a number of key benefits. Firstly, a data network constructed using this method and system may provide continuous coverage over a large area. Secondly, the system may be automated to a large extent, thereby reducing cost and increasing scalability of the business model. Thirdly, individual business offers to potential customers may be generated at a time when both costs and benefits of such an offer can be accurately predicted.

Hence there is provided a method for predicting performance in a data network, wherein the data network comprises at least one server, a number of existing access points, and at least one client device, wherein the at least one server is operatively connected to at least one of the number of existing access points, the number of existing access points are being arranged to be connected by access point communications links, the at least one client device is arranged to be connected to at least one of the number of existing access points by at least one client communications link wherein the data network further comprises a first database connected to the server, the first database comprising an association between a user and at least one geographical position and an association between the user and at least one client device, and a second database connected to the server, the second database comprising client communications link information pertaining to the client communications links in a subset of said data network, wherein the method comprises associating one of the at least one geographical positions with a set of client communications link measurements related to a client device at a time instant, and predicting a first performance factor pertaining to an access point communications link between a new access point at the geographical position and one of the number of existing access points, wherein the prediction is being based on a subset of the set of client communications link measurements, and wherein the subset is associated with one of the number of existing access points.

Such a method allows for predicting the local link performance for adding a potentially new access point to the data network at a geographical position, thereby expanding the data network in a controlled manner. This information is beneficial for solving the problem of how to properly place a number of access points in a data network.

The method may further comprise predicting a second performance factor pertaining to the deployment of the new access point at the geographical position in the data network based on the first performance factor.

The second performance factor may concern at least one property from the group of: network coverage, network capacity, network reliability. Hence the second performance factor may pertain to the performance of the data network as a whole. This information is beneficial for solving the problem of how to control the growth of a data network.

The prediction of the second performance factor may further involve using a routing algorithm.

The client communications link measurement may indicate that the probability of the client device being used within a pre-determined radius of the geographical position at the particular time instant falls within a predetermined confidence interval.

The first performance factor may concern at least one property from the group of signal-to-noise ratio, bit error rate, signal strength, signal jitter, and signal latency.

The geographical position in the first database may at least comprise a physical address of each user and the second database may further comprise at least one element from the group of: at least one geographical position of the at least one client device, the cumulative access time for the at least one client device at the at least one geographical position, foliage, and line-of-sight between the at least one client device and the at least one access point.

The client communications links may be associated with data traffic, wherein the data traffic pertains to at least one type of service from the group of: Internet service, television service, and telephony service.

There is also provided a method for predicting a network performance factor in a data network, wherein the method comprises predicting at least one first performance factor value according to the above method for predicting performance in a data network for each one of a plurality of geographical positions, associating each one of the plurality of geographical positions with the at least one first performance factor value, and predicting a plurality of second performance factors corresponding to the plurality of geographical positions, wherein each one of the second performance factors pertain to the deployment of a new access point at each of the geographical positions in a subset of the data network based on the first performance factor.

This method may further comprise selecting at least one of the plurality of geographical positions for the deployment of a new access point based on the predicted plurality of second performance factors.

There is also provided a method for deploying a data network, Wherein the method comprises receiving a plurality of geographical positions pertaining to the deployment of a new access point in the data network, receiving client communications link measurements for the plurality of geographical positions, predicting a network performance factor for at least one of the plurality of geographical positions in the data network according to the above method for predicting a network performance factor in a data network based on the received measurements, selecting at least one of the plurality of geographical positions for the deployment of a new access point based on the predicted plurality of second performance factors, and generating at least one client device dedicated plan based on the selected at least one geographical position. The at least one client device may be associated with the geographical position.

The at least one client device dedicated plan may comprise changing the client dedicated capacity of the client communications link between the at least one operatively connected client device and the at least one existing access point of the data network.

The at least one client device dedicated plan may comprise finding a physical address corresponding to one of the at least one geographical position, and adding the new access point to the data network at the physical address.

The at least one client device dedicated plan may further comprise generating at least one business offer. The at least one client device dedicated plan may further comprise sending at least one of the at least one business offer to at least one of the at least one client device.

According to another aspect there is provided a server, wherein the server is being operatively connectable to at least one of a number of access points in a data network, the number of existing access points being arranged to be connected by access point communications links, wherein the data network further comprises at least one client device, the at least one client device being arranged to be connected to at least one of the number of existing access points by at least one client communications link, a first database connected to the server, the first database comprising an association between a user and at least one geographical position and an association between the user and at least one client device, and a second database connected to the server, the second database comprising client communications link information pertaining to the client communications links in a subset of the data network, wherein the server comprises circuitry configured to associate one of the at least one geographical positions with a set of client communications link measurements related to a client device at a time instant and predict a first performance factor pertaining to an access point communications link between a new access point at the geographical position and one of the number of existing access points, wherein the prediction is being based on a subset of the set of client communications link measurements, and wherein the subset is associated with one of the number of existing access points.

The server may further comprise circuitry configured to predict a second performance factor pertaining to the deployment of the new access point at the geographical position in the data network based on the first performance factor. The server may further comprise circuitry configured to find a physical address corresponding to one of the at least one geographical position.

The server may further comprise circuitry configured to change the client dedicated capacity of the client communications link between the at least one operatively connected client device and the at least one existing access point of the data network.

The server may further comprise a captive portal, wherein the captive portal comprises circuitry configured to request authentication information from the at least one client device, and provide the at least one client device with service information.

The server may further comprise a customer relationship management system and the first database may be stored in a customer relationship management system. The customer relationship management system may further comprise circuitry configured to transmit information from the first database and the second database to a user interface apparatus.

The server may further comprise a network planning system, wherein the network planning system comprises circuitry configured to receive the client communications link information from the second database, receive new client communications link information, receive the predicted first performance factor, receive the user information from the first database, and generate an internal representation of the data network based on the client communications link information, the new client communications link information, the access point communications link information and the user information.

The customer relationship management system may comprise circuitry configured to generate at least one business offer based on information in the first database, information in the second database and the internal representation, and furthermore associate the at least one business offer with the at least one client device. The service information may comprise at least one element from the group of: maintenance service, and the at least one business offer.

The captive portal may further comprise circuitry configured to retrieve the at least one business offer from the customer relationship management system, and provide the associated at least one client device with the at least one business offer.

The captive portal, the customer relationship management system and the network planning system may be comprised in the server.

According to yet another aspect there is provided a system comprising a server and data network according to the above, wherein the data network further comprises at least one gateway, and wherein the server is connected to the at least one gateway, and wherein the at least one gateway is operatively connected to the data network and a service providing data network by a plurality of communications links.

The system may further comprise at least one router, and a subset of the data network may be operatively connected to the at least one router. Each of the at least one gateways may be associated with at least one service provider.

There is also provided a computer program product, comprising computer program code stored on a computer-readable storage medium which, when executed on a processor, carries out the method for predicting a performance factor pertaining to a communications link in a data network according to the above.

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 is a schematic illustration of a data network, as an example of an environment in which the present invention may be applied.

FIG. 2a is a schematic illustration of a captive portal, a customer relationship management system, and a network planning system according to an embodiment.

FIG. 2b is a schematic illustration of a server comprising a captive portal, a customer relationship management system, and a network planning system according to an embodiment.

FIG. 3 is a schematic illustration of a data network, as an example of an environment in which the present invention may be applied.

FIG. 4 is a schematic illustration of a data network, as an example of an environment in which the present invention may be applied.

FIGS. 5a-5b present flow charts illustrating a method for predicting performance in a data network according to an embodiment.

FIG. 6a presents a flow chart illustrating a method for predicting a network performance factor in a data network according to an embodiment.

FIG. 6b presents a flow chart illustrating a method for deploying a data network according to an embodiment

FIGS. 7a-7b are schematic illustrations of a part of a data network.

FIG. 6 is a schematic illustration of a part of a data network.

### DETAILED DESCRIPTION OF EMBODIMENTS

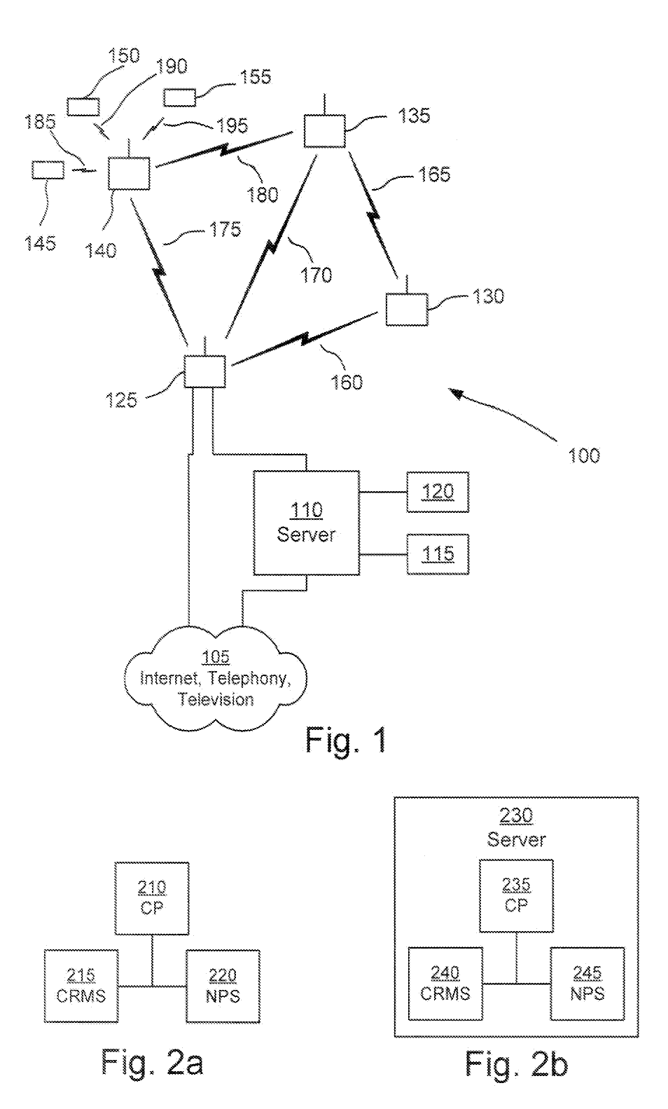

FIG. 1 illustrates an example of a data network 100 in which the invention may be applied. In the data network 100 of FIG. 1, various network services such as cellular voice calls, Internet browsing, wap browsing, cellular video calls, data calls, facsimile transmissions, music transmissions, still image transmissions, video transmissions, television transmissions, electronic message transmissions, data downloading, general data transmission, electronic positioning information, and electronic commerce may be performed between a client device 145, 150, 155, such as a mobile phone, a personal digital assistant, a laptop computer, a portable media device, or any portable device having a communications interface, and a service providing network 105, such as a wide area network (including the Internet), a television network, or a telephony network. Hence the data network 100 is accessed by users using the client device 145, 150, 155.

The client devices 145, 150, 155 are operatively connected to the service providing network 105 via at least one access point 125, 130, 135, 140. More particularly, the client devices 145, 150, 155 are operatively connected to the at least one access point 125, 130, 135, 140 via client communications links 185, 190, 195, and the access points 125, 130, 135, 140 are interconnected by access point communications links 160, 165, 170, 175, 180.

The client communications links may be associated with data traffic and the data traffic may pertain to at least one type of service from the group of: Internet service, television service, and telephony service. However, as is known to a person skilled in the art, the client communications links may also be associated with non-user dedicated traffic, such as pilot signals, control signals, roaming information, positioning information, or other non-user dedicated traffic.

The client communications link 185 of FIG. 1 operatively connects the client device 145 with the access point 140. However, since the client devices 145, 150, 155 are free to roam within a part of the data network defined by the coverage area of the access points 125, 130, 135, 140 of the data network 100, a situation may occur in which a client device currently is operatively connected to a first access point and at a later time instant is operatively connected to a second access point. A situation may also occur in which a client device simultaneously is capable of communicating with a plurality of access points.

Furthermore the access point 140 is operatively connected to the access point 125 via the access point communications link 175. The client communications links 185, 190, 195 may be wireless, wired, or a combination thereof. The access point communications links 160, 165, 170, 175, 180 may be wireless, wired, or a combination thereof.

Examples of wireless transmission technologies suitable for the present invention include, but is not limited to, GSM (Global System for Mobile communications), EDGE (Enhanced Data rates for GSM Evolution), UMTS (Universal Mobile Telecommunications System), Microwave links, WiMAX (Worldwide interoperability for Microwave Access), or any of the IEEE 802.11x network standards (Institute of Electrical and Electronics Engineers). Examples of wired transmission technologies suitable for the present invention include, but is not limited to, ADSL (Asymmetric Digital Subscriber Line), any other digital subscriber line technology (xDSL), Ethernet IEEE 802.3, or optical fiber communications.

At least one of the access points 125, 130, 135, 140 is operatively connected to the service providing network 105. Further, at least one of the access points 125, 130, 135, 140 is operatively connected to a server 110. In one embodiment the server 110 may be connected to a first database 115 and a second database 120. Here the terms “first” and “second” should be interpreted widely and are just means for simplify the notation; for example the content of the first database 115 and the second database 120 may be stored in a single database.

The first database 115 may comprise an association between a user and at least one geographical position and furthermore an association between the user and at least one client device. In one embodiment the geographical position corresponds to a physical address of the user. It should be noted that a user may be associated with several geographical locations (corresponding e.g. to a home address and a work address, respectively) and with several client devices (such as a laptop and a PDA, respectively) 145, 150, 155.

The second database 120 may comprise client communications link information pertaining to the client communications links in a subset of the data network. This subset may be defined as the entire data network. In one embodiment the second database 120 further comprises at least one element from the group of: at least one geographical position of the client devices 145, 150, 155, the cumulative access time for each of the client devices 145, 150, 155 at the geographical positions where each client device 145, 150, 155 has been used, foliage, and line-of-sight between each client device 145, 150, 155 and one or more access points 125, 130, 135, 140.

Hence information pertaining to circumstances that may affect the performance of the communications link, such as clear line-of-sight or the presence of obstacles such as foliage, between each client device 145, 150, 155 and access point 125, 130, 135, 140 may also be considered in the client communications link information.

The server 110 may comprise circuitry configured to associate at least one of the geographical positions with a set of client communications link measurements for a client device 145, 150, 155 at a time instant. It may further comprise circuitry configured to predict a first performance factor pertaining to an access point communications link between a (potentially) new access point at the geographical location and one or more of the existing access points 125, 130, 135, 140. The first performance factor may concern at least one property from the group of signal-to-noise ratio, bit error rate, signal strength, signal jitter, and signal latency.

As is known to a person skilled in the art the signal-to-noise ratio is defined as the ratio of the signal power to the noise power corrupting the signal, and the bit error rate is the ratio of the number of bits, elements, characters, or blocks incorrectly received to the total number of bits, elements, characters, or blocks sent during a specified time interval.

The client communications link measurement may indicate that the probability of the client device 145, 150, 155 being used within a predetermined radius of the geographical position at a specific time instant falls within a pre-determined confidence interval.

The server 110 may further comprise circuitry to predict a second performance factor pertaining to the deployment of the new access point at this geographical location in the data network based on the first performance factor. In one embodiment the second performance factor may concern at least one property from the group of: network coverage, network capacity, and network reliability.

The network coverage may be predicted using a number of methods, e.g. by measuring radio link quality between access points 125, 130, 135, 140 and client devices 145, 150, 155, processing of customer complaints with location information, or direct measurement by so called wardriving, wherein radio signal information is collected in combination with GPS (Global Positioning System) location data. Such predicts may be used by the network planning system to generate offers to potential customers in areas with poor coverage that include a condition to install and operate an access point, thereby improving coverage.

Furthermore, the network capacity is a function of the total (channel) capacity for each communications link, wherein the (channel) capacity is defined as an upper bound on the amount of information that can be reliably transmitted over each communications link. The network reliability is here defined as the ability of a system or component to perform its required functions under stated conditions for a specified period of time.

As will be described below with reference to FIG. 2b the server 110 may include further means for controlling the data network thus formed.

FIG. 2a illustrates a captive portal 210, a customer relationship management system 215, and a network planning system 220 according to an embodiment.

As indicated in FIG. 2a the captive portal 210, the customer relationship management system 215, and the network planning system 220 are internally interconnected. However the captive portal 210, the customer relationship management system 215, and the network planning system 220 may also be able to communicate and send data to/from other devices and apparatuses, such as the server 110 (and there from to the client devices 145, 150, 155), the first database 115 and the second database 120 of FIG. 1.

The captive portal 210 can comprise circuitry configured to request authentication information from a client device 145, 150, 155, and provide the client device 145, 150, 155 with service information. In one embodiment these information messages are transmitted to/from the client device 145, 150, 155 via the server 110. It should be noted that at least part of the functionalities of the captive portal 210, as herein disclosed, may be provided as computer program code.

The first database 115 may be stored in a customer relationship management system 215. It should be noted that at least part of the functionalities of the customer relationship management system 215, as herein disclosed, may be provided as computer program code. The customer relationship management system may further comprise circuitry configured to transmit information from the first database 115 and the second database 120 to a user interface apparatus via the server 110, or by using a separate communications interface (not shown in FIG. 2a). Using such a user interface apparatus an operator may supervise the data network 100. For example, such a user interface apparatus may comprise a graphical user interface displaying various aspects of the data network, such as, but not limited to, the information contained in the first 115 and second 120 databases, respectively.

In more detail, such a user interface apparatus may retrieve the information stored in the customer relationship management system 215 and network planning system 220 and may further visualize it in a map view of the coverage area. The location of access points 125, 130, 135, 140 and client devices 145, 150, 155 can be visualized as color coded dots, the quality of radio links can be visualized as color coded lines, and the volume of traffic transferred through individual communications links can be visualized by adjusting the thickness of such lines in the map view. Locations at which new access points could be installed can be visualized as selectable points in the map view.

The network planning system 220 comprises circuitry configured to receive client communications link information from the second database 120, receive new client communications link information, receive the predicted first performance factor, receive user information from the first database 115, and generate an internal representation of the data network based on the client communications link information, the new client communications link information, the access point communications link information and the user information. This internal representation may also be communicated to the user interface apparatus discussed above. It should be noted that at least part of the functionalities of the network planning system 220, as herein disclosed, may be provided as computer program code.

The customer relationship management system 215 may further comprise circuitry configured to generate at least one business offer based on information in the first database 115, information in the second database 120 and the internal representation disclosed above, and to associate the business offer with at least one client device 145, 158, 155.

Hence the service information may comprise at least one element from the group of maintenance service and a business offer. The captive portal 210 may further comprise circuitry configured to retrieve the business offer from the customer relationship management system 220, and to provide at least one of the client devices 145, 150, 155 with the business offer.

Thus, using said user interface apparatus a human operator may select clients or client devices 145, 150, 155, view detailed information collected about them and generate an individual business offer for that client or client device 145, 150, 155 using an input form.

As is illustrated in FIG. 2b, according to an embodiment the captive portal 210, 235, the customer relationship management system 215, 240, and the network, planning system 220, 245 may be included in a server 230, such as the server 110 of FIG. 1.

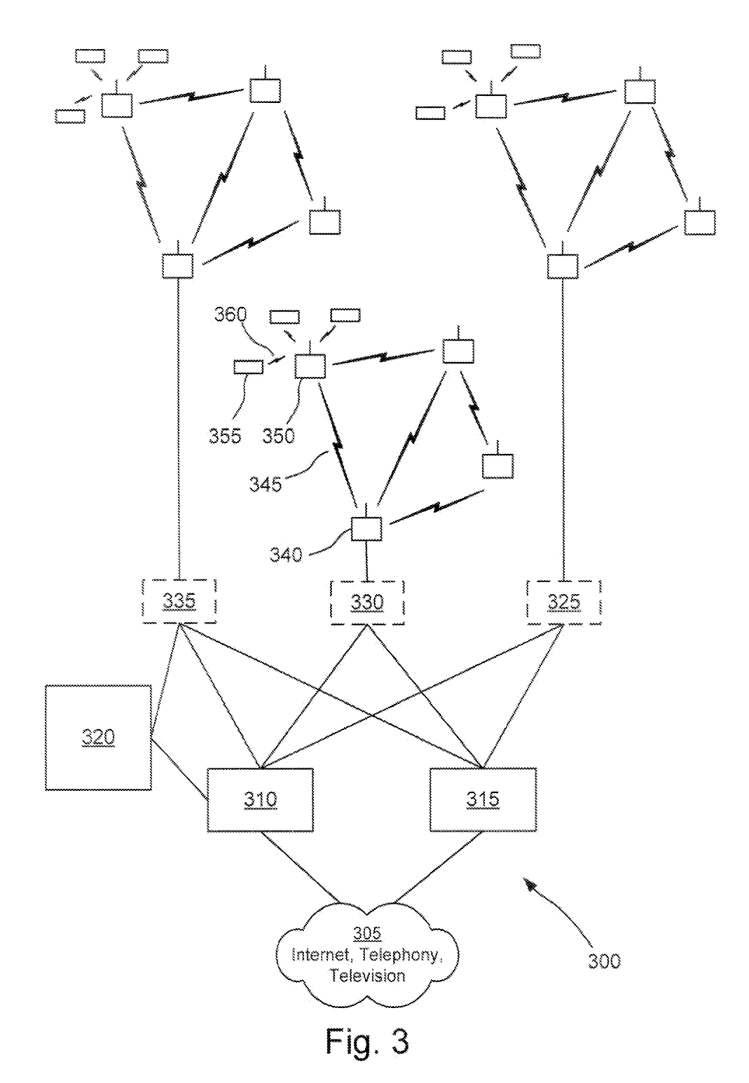

FIG. 3 illustrates an embodiment of a data network 300 in which the invention may be applied. As in the data network 100 of FIG. 1 various network services may be performed between a client device 355 and a service providing network 305.

The client device 355 is operatively connected to the service providing network 305 via at least one access point 340, 350 and furthermore via a router 325, 330, 335 and a gateway 310, 315. Particularly, the client device 355 is operatively connected to at least one access point 340, 350 via client communications links 360, and the access points 340, 350 are interconnected by access point communications links 345.

Note that in FIG. 3 a number of client devices, access points, client communications links, and access point communications links are illustrated, but for clarity only one of the client devices, two of the access points, one of the client communications links and one of the access point communications links have been assigned a reference numeral (marked as client device 355, access points 340, 350, client communications link 360, and access point communications link 345).

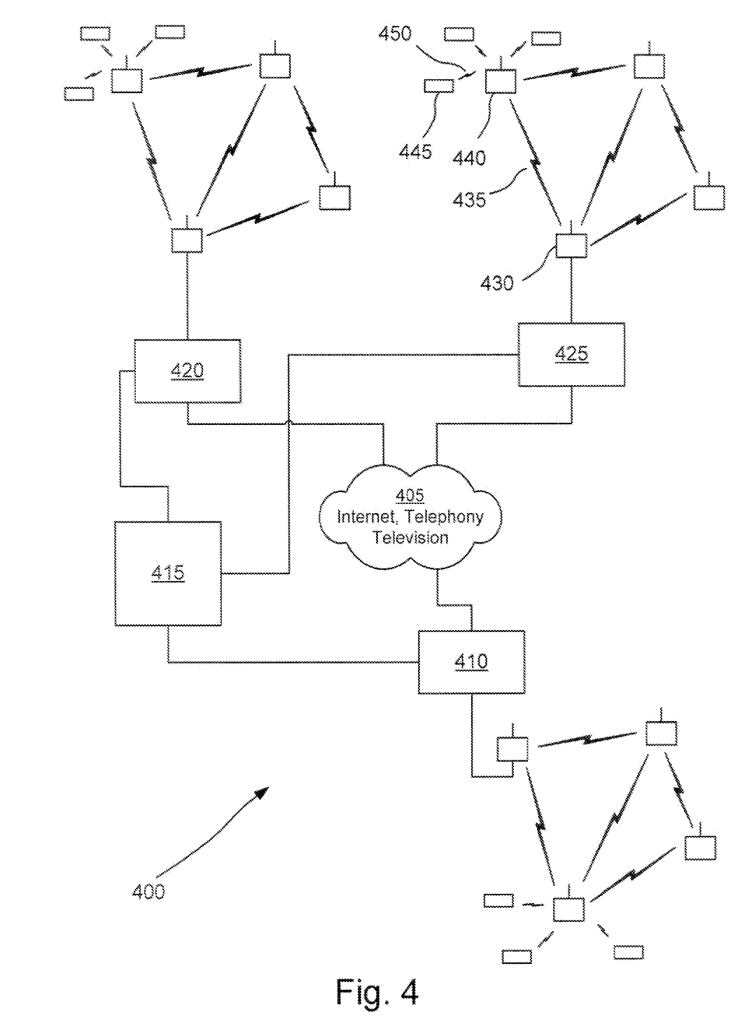

The routers 325, 330, 335 are optional, as indicated by the dashed lines in FIG. 3. In a system according to FIG. 3 without routers 325, 330, 335 the at least one access point 34Q 350 is operatively connected to the at least one gateway 310, 315. This will be further discussed with reference to FIG. 4 below.

Each of the gateways 310, 315 may be associated with a particular service operator. For example gateway 310 may be associated with a first service operator and gateway 315 may be associated with a second service operator. An example of a service operator is a service operator offering broadband Internet subscriptions to at least a subset of client devices of the data network defined by the access points and client devices of the system 300 in FIG. 3. A second example of a service operator is a service operator offering television service to at least a subset of client devices of the data network defined by the access points and client devices of the system 300 in FIG. 3. A third example of a service operator is a service operator offering telephony service to at least a subset of client devices of the data network defined by the access points and client devices of the system 300 in FIG. 3.

The routers 325, 330, 335 are configured to associate the client device 355 with a particular service operator and hence a particular gateway 310, 315. However, in one embodiment each gateway 310, 315 may be associated with a plurality of different service operators.

The gateways 310, 315 and the routers 325, 330, 335 are connected to a server 320, which preferably is a server according to the server 110 of FIG. 1 or the server 230 of FIG. 2b.

Continuing now with FIG. 4 which illustrates a data network 400 in which the invention may be applied. As in the data network 100 of FIG. 1 various network services may be performed between a client device 445 and a service providing network 405.

The client device 445 can be operatively connected to the service providing network 405 via at least one access point 430, 440 and furthermore via a gateway 410, 420, 425. The client device 445 can be operatively connected to at least one access point 430, 440 via client communications links 450, and the access points 430, 440 can be interconnected by access point communications links 435.

Note that in FIG. 4 a number of client devices, access points, client communications links, and access point communications links are illustrated, but for clarity only one of the client devices, two of the access points, one of the client communications links and one of the access point communications links have been assigned a reference numeral (marked as client device 445, access points 430, 440, client communications link 450 and access point communications link 435).

Each of the gateways 410, 420, 425 may be associated with a particular service operator. For example gateway 410 may be associated with a first service operator, gateway 420 may be associated with a second service operator and gateway 425 may be associated with a third service operator. The gateways 410, 420, 425 are connected to a server 415, which preferably is a server according to the server 110 of FIG. 1 or the server 230 of FIG. 2b.

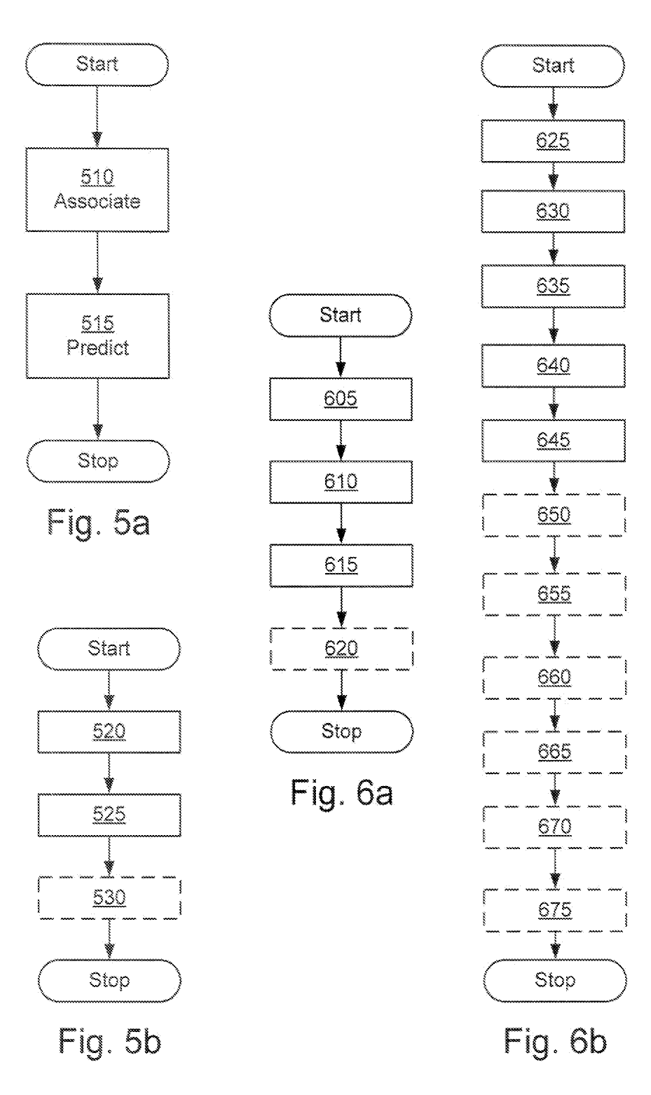

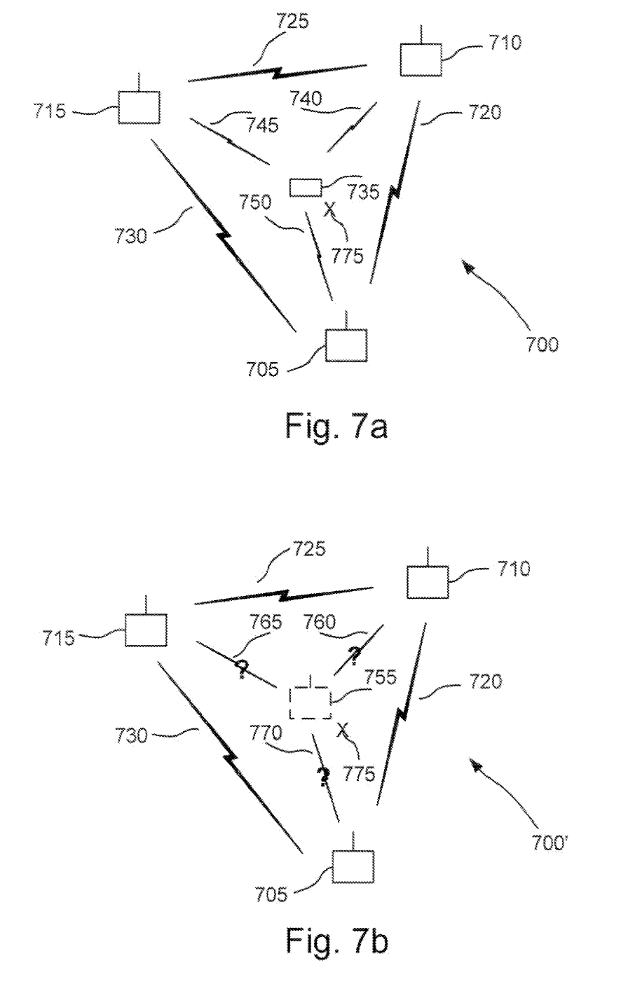

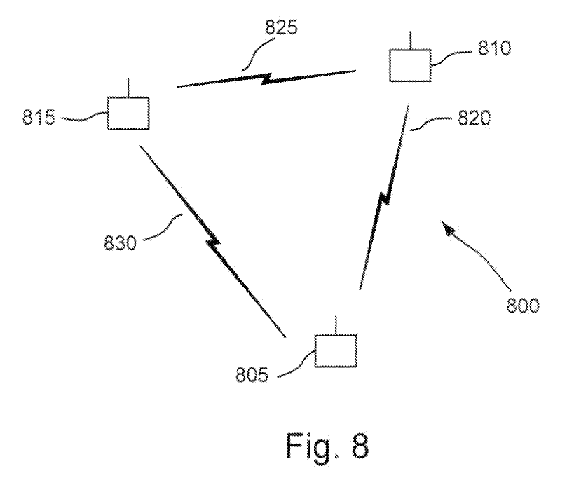

A method for predicting performance in a data network, such as the data networks 100, 300, 400 of FIGS. 1, 3 and 4, will be described next with reference to the flowchart of FIG. 5a and FIGS. 7a-7b, FIGS. 7a-7b are schematic illustrations of a part 700, 700′ of a data network, such as the data networks 100, 300, 400 of FIGS. 1, 3 and 4.

In a preferred embodiment at least one geographical position is associated 510 with a set of client communications link measurements for a client device 735 at a time instant. The at least one geographical position may be comprised in a first database, which database can be connected to at least one server (not explicitly shown in FIGS. 7a-7b) in a data network. The first database may further comprise an association between a user and the at least one geographical position 775 and an association between the user and at least one client device 735. The data network may comprise a number of existing access points 705, 710, 715, and at least one client device 735. The at least one server can be operatively connected to at least one of the number of existing access points 705, 710, 715, and the number of existing access points 705, 710, 715 can be arranged to be connected by access point communications links 720, 725, 730. The at least one client device 735 can be arranged to be connected to at least one of the number of existing access points 705, 710, 715 by at least one client communications link 740, 745, 750.

A first performance factor pertaining to an access point communications link 760, 765, 770 between a new access point 755 at the geographical location (as defined above) and one of the number of existing access points 705, 710, 715 is then predicted 515. Note that in FIG. 7b the new access point 755 has been indicated by dashed lines and the access point communications links 760, 765, 770 have been marked with question mark symbols “?” to indicate that the performance factor pertaining to these links needs to be predicted since the new access point 755 has not yet been deployed.

Further embodiments of the method will be described next with reference to the flowchart of FIG. 5b. As in the flowchart of FIG. 5a at least one geographical position is associated 520 with a set of client communications link measurements for a client device at a time instant; and a first performance factor pertaining to an access point communications link between a new access point at the geographical location and one of the number of existing access points is predicted 525.

A second performance factor pertaining to the deployment of the new access point 755 at the geographical location 775 in the data network based on the first performance factor can be predicted 530.

The prediction 530 can be based on a subset of client communications link measurements, wherein said subset can be associated with one of the number of existing access points. A set of client communications link measurements may be comprised in a second database, which database comprises client communications link information pertaining to the client communications links 740, 745, 750 in a subset of the data network, and which database is connected to the at least one server in the data network.

Hence, such a method enables the prediction of a suitable location for a new access point 755 in a data network based on information provided from already existing access points 705, 710, 715, client devices 735 operating in the data network, information pertaining to communications links between client devices and access points (so-called client communications links 740, 745, 750), and information pertaining to communications links between access points (so-called access point communications links 720, 725, 730).

The client communications link measurement may indicate that the probability of the client device being used within a pre-determined radius of the geographical position at the time instant falls within a pre-determined confidence interval. Moreover, the first performance factor may concern at least one property from the group of: signal-to-noise ratio, bit error rate, signal strength, signal jitter, and signal latency. The second performance factor may concern at least one property from the group of: network coverage, network capacity, network reliability.

Furthermore, the geographical position in the first database may at least comprise a physical address of the user, and the second database may further comprise at least one element from the group of at least one geographical position of the at least one client device, the cumulative access time for the at least one client device at the at least one geographical position, foliage, and line-of-sight between the at least one client device and the at least one access point. The cumulative access time may be provided by a service provider or operator.

As mentioned above, the client communications links may be associated with data traffic, wherein the data traffic pertains to at least one type of service from the group of: Internet service, television service, and telephony service.

The prediction of the second performance factor may involve using a routing algorithm. One example of a routing algorithm that may be used is a mesh routing algorithm. The mesh routing algorithm may also be used for optimizing the data traffic flow in the data network.

The routing algorithm may be extended to not only converge on close to optimal routes as in current state of the art systems, but to also generate information about bottlenecks in the network preventing the algorithm from choosing even better routes. This information could be used by the network planning system to generate favorable offers including a condition to install and operate an access point to suitable potential customers. With a solution of this type the placement of network nodes could be considered as output from the route optimization algorithm and not as a form of input as in current state of the art solutions.

According to one embodiment the method may further comprise predicting a plurality of network performance factors corresponding to a plurality of geographical positions in a data network. As shown in the flow-chart of FIG. 6a the Method comprises predicting 605 at least one first performance factor value according to the flowchart of FIG. 5a or 5b for each one of the plurality of geographical positions and associating 610 each one of the plurality of geographical positions with the at least one first Performance factor value. A plurality of second performance factors corresponding to the plurality of geographical positions may then be predicted 615. Each one of the second performance factors pertain to the deployment of a new access point at each of the geographical positions in a subset of the data network based on the first performance factor.

The method may further comprise selecting 620 at least one of the plurality of geographical positions for the deployment of a new access point based on the predicted plurality of second performance factors.

There is also provided a method for deploying a data network. As shown in the flowchart of FIG. 6b the method comprises comprising receiving 625 a plurality of geographical positions pertaining to the deployment of a new access point in the data network, and receiving 630 client communications link measurements for the plurality of geographical positions.

A network performance factor according to the flowchart of FIG. 6a for at least one of the plurality of geographical positions in the data network based on said received measurements may then be predicted 635. Based on said predicted plurality of second performance factors at least one of said plurality of geographical positions may be selected 640 for the deployment of a new access point. Furthermore at least one client device dedicated plan based on the selected at least one geographical position may be generated 645. The at least one client device may be associated with the geographical position.

In one embodiment the method further comprises generating 650 at least one client device dedicated plan based on the prediction of deploying the new access point, wherein the at least one client device is associated with the geographical location.

In one embodiment the at least one client device dedicated plan comprises changing 655 the client dedicated capacity of the client communications link between the at least one operatively connected client device and the at least one existing access point of said data network.

In one embodiment the at least one client device dedicated plan comprises finding 660 a physical address corresponding to one of the at least one geographical position; and adding 665 the new access point to the data network at the physical address.

The at least one client device dedicated plan may further comprise generating 670 at least one business offer, wherein the business offer may depend on the second performance factor. The at least one client device dedicated plan may furthermore comprise sending 675 at least one of the at least one business offer to at least one of the at least one client device.

In one embodiment the business offer depends on an investment evaluation, wherein the investment evaluation is based on the second performance factor. For example if the deployment of a new access point 755 at said geographical location 775 will increase the data network coverage, the data network capacity, and/or the data network reliability by a factor which is higher than a pre-defined threshold value, the business offer includes offering the user of the client device 735 associated with the geographical location 775 to install the new access point 755 at the user's premises for free.

In a more general situation a factor for increased data network coverage, data network capacity, and/or data network reliability may be mapped to a particular business offer. For example there may be a multitude of levels of business offers, wherein each level is mapped to a corresponding level of the factor for increased data network coverage, data network capacity, and/or data network reliability. A business offer may include a monthly subscription fee for accessing the data network 100, 300, 400. Hence different levels of the factor for increased data network coverage, data network capacity, and/or data network reliability may be mapped to different levels of monthly subscription fees, Such a subscription fee level may be determined by a service operator. The business offer, and hence also the monthly subscription fees, may also depend on whether or not an existing access point already is installed at the premises of the user of the client device 735.

A method for predicting the access quality in a data network, such as the data networks 100, 300, 400 of FIGS. 1, 3 and 4, will be described next with reference to FIG. 8. FIG. 8 is a schematic illustration of a part 800 of a data network, such as the data networks 100, 300, 400 of FIGS. 1, 3 and 4. The part 800 of the network comprises a plurality of access points 805, 810, 815 interconnected by access point communications links 820, 825, 830.

A third performance factor based on the access point communications links 820, 825, 830 is measured or predicted, wherein the performance factor concerns at least one property from the group of: the signal-to-noise ratio of the access point communications links, the bit error rate of the access point communications links, the signal strength of the access point communications links, the jitter of the of the access point communications link signals, and the latency of the of the access point communications link signals. Using this predicted or measured third performance factor a fourth performance factor for the data network concerning at least one property from the group of: network coverage, network capacity, network reliability may be predicted.

Hence such a method allows for planning the layout of a data network. In more detail, such a method may be used in order to predict the increased capacity of the data network by adding a new access point within a predefined radius of a geographical location, wherein the geographical location is determined by the fourth performance factor.

In other words, a captive portal is, in general terms, an interface that is presented to a customer in place of any content the customer has requested from the network. It can be used to request that the customer authenticates using a user name and password before access to the services of the network is granted.

The captive portal handles user authentication and registration. The captive portal can also be used to display relevant information about the services of the network and collect feedback from potential and existing customers in connection with the authentication procedure.

The customer relationship management system stores, organizes and presents information about, individual (existing or potential) customers.

The network planning system continuously collects information from the access points in the network. This information may include which client devices are currently served by a certain access point, the quality of that service, the radio link quality between access point and client device, the amount of traffic transferred through and the quality of both used and unused radio links between access points in the network. This information is used to construct an internal representation of the network.

The network planning system may furthermore be connected to an automatic direct mail advertising service so that e.g. special offers can be directed to large numbers of potential customers in areas where new access points are needed.

To construct a network using the herein disclosed method, server and system, first a set of access points with connections to a service providing data network, such as the Internet, are installed using traditional methods. These access points serve as a seed for the data network. Around these access points a dense data network of access points is then deployed using the herein described method and system to form a network with continuous coverage over a large area.

When a user connects to an access point (with a wireless or wired connection to the Internet) they are presented with the captive portal. The captive portal requests that the user registers or inputs a user name and password to authenticate as an existing or potential customer. If the user authenticates as an existing or potential customer then access to the services of the network, such as e.g. Internet access, is granted. This temporary access may be granted free of charge. If the user chooses to register as a potential customer the captive portal requests information from the user such as name and address. The captive portal can also request information about any physical characteristics of the surroundings of the customer's home that might affect radio wave propagation, e.g. the location of windows, foliage and line-of-sight to other locations.

The captive portal forwards the information to the customer relationship management system where it is stored. The potential customer is then granted temporary access to the network under a short term contract.

During the temporary access period the network planning system collects information from the network as detailed above. Using this information a compound internal representation of the network is constructed. Using this internal representation together with the information stored in the customer relationship management system the network planning system generates an offer for the potential customer and stores it in the customer relationship management system. The offer may include conditions limiting the network resource use of the potential customer. The offer may also include a condition that the potential customer installs and operates an access point in his home, thereby extending the network.

The customer relationship management system may order a delivery of such an access point device through an automatic logistics system. The access point may then be delivered to the customer's home address.

By choosing to include or not to include such a condition in the offer the network planning system can control the deployment of the network. However, note that not only the potential customer's home, but any location at which the customer could install and operate an access point could be evaluated for deployment of a new access point.

Using the radio link quality information stored in the network planning system and the location of access points stored in the customer relationship management system client devices may be located. This procedure can be used to provide navigation services or location based advertising.

Generally, all terms used in the claims are to be interpreted according to their ordinary meaning in the technical field, unless explicitly defined otherwise herein. All references to “a/an/said/the [device, component, etc]” are to be interpreted openly as referring to at least one instance of said device, component, etc., unless explicitly stated otherwise. The steps of any method disclosed herein do not have to be performed in the exact order disclosed, unless explicitly stated.

The invention has mainly been described above with reference to a few embodiments. However, as is readily appreciated by a person skilled in the art other embodiments than the ones disclosed above are equally, possible within the scope of the invention, as defined by the appended patent claims.

1. A method for predicting performance in a data network, said data network comprising
at least one server,
a number of existing access points,
at least one client device, wherein
said at least one server is operatively connected to at least one of said number of existing access points,
said number of existing access points being arranged to be connected by access point communications links, and
said at least one client device being arranged to be connected to at least one of said number of existing access points by at least one client communications link
a first database connected to said at least one server, said first database comprising an association between a user and at least one geographical position and an association between said user and at least one client device, and
a second database connected to said at least one server, said second database comprising client communications link information pertaining to said client communications links in a subset of said data network, said method comprising:
associating one of said at least one geographical positions with a set of client communications link measurements related to a client device at a time instant; and
predicting a first performance factor pertaining to an access point communications link between a new access point at said geographical position and one of said number of existing access points, said prediction being based on a subset of said set of client communications link measurements, wherein said subset is associated with said one of said number of existing access points.

2. The method according to claim 1 further comprising
predicting a second performance factor pertaining to the deployment of said new access point at said geographical position in said data network based on said first performance factor.

3. The method according to claim 2 wherein
said second performance factor concerns at least one property from the group of: network coverage, network capacity, network reliability.

4. The method according to claim 1, wherein the prediction of said second performance factor involves using a routing algorithm.

5. The method according to claim 1, wherein
said client communications link measurement indicates that the probability of said client device being used within a pre-determined radius of said geographical position at said time instant falls within a pre-determined confidence interval.

6. The method according to claim 1, wherein
said first performance factor concerns at least one property from the group of: signal-to-noise ratio, bit error rate, signal strength, signal jitter, and signal latency.

7. The method according to claim 1, wherein
said geographical position in said first database at least comprises a physical address of said user.

8. The method according to claim 1, wherein
said second database further comprises at least one element from the group of: at least one geographical position of said at least one client device, cumulative access time for said at least one client device at said at least one geographical position, foliage, and line-of-sight between said at least one client device and said at least one access point.

9. The method according to claim 1, wherein
said client communications links are associated with data traffic, said data traffic pertaining to at least one type of service from the group of: Internet service, television service, and telephony service.

10. A method for predicting a network performance factor in a data network, said method comprising
predicting at least one first performance factor value according to claim 1 for each one of a plurality of geographical positions;
associating each one of said plurality of geographical positions with said at least one first performance factor value; and
predicting a plurality of second performance factors corresponding to said plurality of geographical positions, wherein each one of said second performance factors pertain to the deployment of a new access point at each of said geographical positions in a subset of said data network based on said first performance factor.

11. The method according to claim 10 further comprising
selecting at least one of said plurality of geographical positions for the deployment of a new access point based on said predicted plurality of second performance factors.

12. A method for deploying a data network, comprising
receiving a plurality of geographical positions pertaining to the deployment of a new access point in said data network;
receiving client communications link measurements for said plurality of geographical positions;
predicting a network performance factor for at least one of said plurality of geographical positions in said data network according to claim 10 based on said received measurements;
selecting at least one of said plurality of geographical positions for the deployment of a new access point based on said predicted plurality of second performance factors; and
generating at least one client device dedicated plan based on said selected at least one geographical position.

13. The method according to claim 12 wherein
said at least one client device is associated with said geographical position.

14. The method according to claim 13 wherein said at least one client device dedicated plan comprises
changing the client dedicated capacity of the client communications link between said at least one operatively connected client device and said at least one existing access point of said data network.

15. The method according to claim 14 wherein said at least one client device dedicated plan comprises
finding a physical address corresponding to one of said at least one geographical position; and
adding said new access point to said data network at said physical address.

16. The method according to claim 12, wherein said at least one client device dedicated plan further comprises
generating at least one business offer.

17. The method according to claim 16 wherein said at least one client device dedicated plan further comprises
sending at least one of said at least one business offer to at least one of said at least one client device.

18. A server,
operatively connectable to at least one of a number of access points in a data network,
said number of existing access points being arranged to be connected by access point communications links,
said data network further comprising
at least one client device,
arranged to be connected to at least one of said number of existing access points by at least one client communications link,
a first database connected to said server, said first database comprising an association between a user and at least one geographical position and an association between said user and at least one client device, and
a second database connected to said server, said second database comprising client communications link information pertaining to said client communications links in a subset of said data network,
said server comprising circuitry configured to
associate one of said at least one geographical positions with a set of client
communications link measurements related to a client device at a time instant; and
predict a first performance factor pertaining to an access point communications link between a new access point at said geographical position and one of said number of existing access points, said prediction being based on a subset of said set of client communications link measurements, wherein said subset is associated with said one of said number of existing access points.

19. The server according to claim 18 further comprising circuitry configured to
predict a second performance factor pertaining to the deployment of said new access point at said geographical position in said data network based on said first performance factor.

20. The server according to claim 18 further comprising circuitry configured to
find a physical address corresponding to one of said at least one geographical position.

21. The server according to any of claim 18 further comprising circuitry configured to
change the client dedicated capacity of the client communications link between said at least one operatively connected client device and said at least one existing access point of said data network.

22. The server according to claim 18 further comprising a captive portal, said captive portal comprising circuitry configured to
request authentication information from said at least one client device; and
provide said at least one client device with service information.

23. The server according to claims 22 wherein
said first database is stored in a customer relationship management system.

24. The server according to claim 23 wherein said customer relationship management system further comprises circuitry configured to
transmit information from said first database and said second database to a user interface apparatus.

25. The server according to claim 22 further comprising a network planning system, said network planning system comprising circuitry configured to
receive said client communications link information from said second database;
receive new client communications link information;
receive said predicted first performance factor;
receive said user information from said first database; and
generate an internal representation of the data network based on said client communications link information, said new client communications link information, said access point communications link information and said user information.

26. The server according to claim 25 wherein said customer relationship management system comprises circuitry configured to
generate at least one business offer based on information in said first database, information in said second database and said internal representation; and
associate said at least one business offer with said at least one client device.

27. The server according to claim 26 wherein said service information comprises at least one element from the group of: maintenance service, and said at least one business offer.

28. The server according to of claim 26 wherein said captive portal further comprises circuitry configured to
retrieve said at least one business offer from said customer relationship management system; and
provide said associated at least one client device with said at least one business offer.

29. The server according to claim 25 wherein said captive portal, said customer relationship management system and said network planning system are comprised in said server.

30. A system comprising
a server according to claim 18,
wherein said data network further comprises
at least one gateway,
and wherein
said server is connected to said at least one gateway, and wherein
said at least one gateway is operatively connected to said data network and a service providing data network by a plurality of communications links.

31. The system according to claim 30 further comprising at least one router, and wherein a subset of said data network is operatively connected to said at least one router.

32. The system according to claim 30 wherein each of said at least one gateways are associated with at least one service provider.

33. A computer program product, comprising computer program code stored on a computer-readable storage medium which, when executed on a processor, carries out the method according to claim 1.
